(19) United States
(12) Patent Application Publication
(10) Pub. No.: US 2024/0362501 A1
(43) Pub. Date: Oct. 31, 2024

(54) FEATURE SELECTION FOR REAL-TIME INFERENCE WITH MULTIPLE UNRELIABLE SENSORS AT THE EDGE

(71) Applicant: Dell Products L.P., Round Rock, TX (US)

(72) Inventors: Pablo Nascimento da Silva, Niterói (BR); Paulo Abelha Ferreira, Rio de Janeiro (BR); Vinicius Michel Gottin, Rio de Janeiro (BR)

(21) Appl. No.: 18/306,578

(22) Filed: Apr. 25, 2023

(51) Int. Cl. G06N 5/022

(52) U.S. Cl. CPC G06N 5/022

(57) ABSTRACT

One example method includes consolidating a data point concerning an autonomous mobile robot that operates in an environment, calculating a lazy feature importance for an available feature of the data point, combining the lazy feature importance with a health score of a sensor that collected data associated with the available feature, to obtain a final feature score for the available feature, selecting a subset of features of the data point, and performing, with a machine learning model, an inference, using only those features in the subset of features, and the inference concerns an aspect of the autonomous mobile robot or the environment.

### FIELD OF THE INVENTION

Embodiments of the present invention generally relate to provisioning of smart services to improve the autonomy of mobile edge devices. More particularly, at least some embodiments of the invention relate to systems, hardware, software, computer-readable media, and methods, for automatically selecting, at a prediction time, a best subset of features for a given prediction based on the health score of a feature, and based on a lazy feature importance measure.

### BACKGROUND

Autonomous mobile edge devices are used to perform tasks in various environments. The performance and operation of such mobile edge devices may be based at least in part on data gathered by one or more sensors deployed on the mobile edge devices and/or one or more sensors deployed in the environment where the mobile edge devices operate. However, the performance and operation of the mobile edge devices may be compromised by sensors that are unreliable in some regard.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses a collection of sensor readings from a mobile edge device added to a near edge database, according to an embodiment.

FIG. 2 discloses training of a machine learning model at a near-edge node and the deployment of the resulting model at the edge, according to an embodiment.

FIG. 3 discloses a multiple-locations environment, with edge-nodes associated to near-edge nodes and near-edge nodes, each at a particular location, associated to a central node A, according to an embodiment.

FIG. 4 discloses operations performed in a centralized training procedure, according to an embodiment.

FIG. 5 discloses collection of feature health scores from edge nodes H_{E} and target environment sensors H_{T}, with collection of both sets of feature health scores by selected edge nodes, and the other edge nodes collecting only H_{E} scores, according to an embodiment.

FIG. 6 discloses a selected edge node Eᵢ sending feature health scores from the environment to a near edge node Nᵢ, according to an embodiment.

FIG. 7 discloses a process for aggregation of the training dataset in a near edge node, according to an embodiment.

FIG. 8 discloses a process for building a training dataset, preprocessing, and training a machine learning model, according to an embodiment.

FIG. 9 discloses the deployment of a model to a production site, according to an embodiment.

FIG. 10 discloses an edge inference process, according to an embodiment.

FIG. 11 discloses a prediction process performed in an edge node after feature selection, according to an embodiment.

FIG. 12 discloses an example computing entity configured and operable to perform any of the disclosed methods, processes, and operations.

### DETAILED DESCRIPTION OF SOME EXAMPLE EMBODIMENTS

Embodiments of the present invention generally relate to provisioning of smart services to improve the autonomy of mobile edge devices. More particularly, at least some embodiments of the invention relate to systems, hardware, software, computer-readable media, and methods, for automatically selecting, at a prediction time, a best subset of features for a given prediction based on the health score of a feature, and based on a lazy feature importance measure.

An embodiment of the invention may comprise a training and preparation stage, and an inference stage. The training stage may comprise collecting a dataset, that may include feature health scores, and then building a strong lazy learner using the dataset. In the inference stage, according to an embodiment, a data point may be consolidated, in an Autonomous Mobile Robot (AMR), that includes respective values for various features. A feature importance for each feature may then be determined, and then combined with a feature health score to obtain a final feature score. The final feature scores may be ranked, and a top group of features selected. The selected features may then be used to perform a prediction in the lazy learner classifier, for example, to predict, or classify, an event experienced by the AMR as being of a particular type.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment of the invention is that an embodiment may be able to overcome unreliable sensor data in generating a prediction, or classification, of an event involving an AMR that either deploys the sensor that generates the sensor data, and/or collects the data from a sensor in an environment where the AMR operates. An embodiment may avoid the need to select an optimum machine learning (ML) model, from a group of ML models, that is to be deployed to a population of edge devices. Various other advantages of one or more embodiments will be apparent from this disclosure.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods, processes, and operations, are defined as being computer-implemented.

### A. Context for an Embodiment of the Invention

Methods have been developed for selecting the best model, that is, a machine learning (ML) model, from a pool of models based on a sensor health score, discarding those models that were less prone to perform well. In an embodiment, a different approach is taken. Particularly, instead of selecting the best model to improve the prediction performance, an embodiment may operate to at adapt a feature set and the model used by a predictive procedure in a lazy fashion, that is, the feature set and, thus, the model that uses the feature set, may be adaptable to each example being predicted.

One promising edge space to work on is smart services for mobile edge devices, for instance, in the logistics space of warehouse management and factories, where there may be multiple mobile devices operating that require real-time decisions. An embodiment may provide smart services to improve the autonomy of these mobile edge devices and add value to customers. The data collected from the trajectories, or travel paths, of these mobile devices as they move about and operate in an environment such as a warehouse for example, may be leveraged into Machine Learning (ML) models to optimize operation of the mobile devices, or to address dangerous circumstances, by way of object/event detection approaches.

One example embodiment is concerned with a factory or logistics warehouse with various multiple mobile edge devices, which may operate autonomously, performing tasks. Each task depends on a large set of sensors to use as input to a machine learning model. Note, however, that in harsh environments, a relevant number of sensors might be faulty, malfunctioning, or noisy. More than that, the subset of sensor data used to perform a given prediction may vary depending on the condition of the edge position inside the warehouse, factory, or other operating environment. Thus, the usage of these data should be made carefully, if at all, since those data could change the output of the models.

An embodiment of the invention may address a feature selection problem for real-time inference using multiple unreliable sensors at the edge in an edge computing environment. Also, a second problem that arises is the selection of the correct features, among those available at the time of selection, is to increase the performance of the predictive model in a lazy fashion, that is, given a specific condition of the environment, how to select the best reliable features and then adapt the ML model to use those features accordingly.

Note that while reference is made herein to a logistics operating environment, such as a warehouse or factory, and to mobile devices such as forklifts, operating in those environments, these are provided only by way of example and are not intended to limit the scope of the invention in any way. Rather, these examples are provided for the purpose of illustrating various concepts, aspects, and features, of one or more embodiments.

### B. Overview of an Embodiment

One example embodiment comprises a method for feature selection for real-time inference using both (1) multiple unreliable sensors, and (2) information importance of each feature calculated in a lazy fashion, that is, an embodiment may calculate the importance of the value of a given feature to the prediction, rather than calculating the importance of the entire feature itself. One embodiment of the invention may comprise a method that includes a training and preparation stage, and an inference stage. These stages are considered in turn below.

A training and preparation stage, according to one embodiment, may comprise the following elements:
[1] periodically obtain feature health scores at the near edge nodes—this information may indicate how reliable a given feature may be considered to be—the reliability, or lack of reliability, may be a function of the sensor itself and/or the conditions in which the sensor operates—for example, if the sensor is deployed on a mobile device that is moving rapidly, the sensor may be unable to gather enough/accurate information about the mobile device and/or the operating environment—as another example, if a sensor is malfunctioning for some reason, the reliability of the information gathered by the sensor may be compromised;
[2] obtain a dataset, with samples of the dataset collected for the features;
[3] pre-process the dataset to enable the calculation of feature importance, relative to one or more other features; and
[4] build a strong lazy learner by using the collected dataset—as used herein, a lazy learner may comprise any classification algorithm operable to adapt to a variable number of features at inference time—examples of such classification algorithms include, but are not limited to, naïve bayes, bayesian networks, and decision trees.

After completion of the training and preparation stage, an embodiment may implement an inferencing stage. An inferencing stage according to one embodiment may comprise the following elements:
[1] at inference time, consolidate a data point inside an edge device, such as an Autonomous Mobile Robot (AMR) for example, for inference—this consolidation may comprise using the collected sensor data, such as feature values for example, to define a data point—that is, a data point may be defined as comprising respective values for each feature in a group of features;
[2] given a data point, calculate the (lazy) feature importance for each one of the features in the data point;
[3] combine the feature importance, per data point, with the feature health score to obtain a final feature score;
[4] for the data point, select the top-k features according to the final feature score—an embodiment may consider both the capacity to perform a good prediction, as well as the health of the sensor from which the data comes—note that since some circumstances may involve a large number of sensors and features, the selected subset of features may be used for a number of rounds, that is, predictions, in order to avoid increasing the computation time; and
[5] use the subset of features to perform the prediction in the lazy learner classifier that was trained in part [4] of the training and preparation stage.

As indicated in the foregoing discussion, an embodiment of the invention may comprise various useful aspects. For example, an embodiment may comprise a method for automatically selecting, at a prediction time, the best subset of features for a given prediction based on both (1) the health score of a feature—which is one example measure of the reliability of the sensor that collected the data pertaining to that feature, and (2) a lazy feature importance measure. This method may then be used to improve the predictions of ML models operating in an edge environment. Thus, one useful aspect of an embodiment may be a method for selecting a different subset of features according to their capabilities to perform more adaptable predictions in real-time edge environments. As another example, an embodiment may reduce bandwidth requirements associated with the collection of data from the sensors by the edge devices, since only data concerning reliable and capable features may need to be collected. Further, an embodiment may enable different edge nodes to have distinct feature health scores according to the reliability of their respective sensors.

### C. Concepts and Information Concerning an Embodiment

One scenario with which an example embodiment may be concerned involves providing smart services for mobile edge devices, which may operate autonomously, in the logistic space of warehouse management and safety, where there may be multiple mobile devices, such as forklifts for example, that require decisions in real time. For example, an autonomous forklift may have to decide to quickly take evasive maneuvers if an obstacle is located in the path of the forklift.

The data collected from the trajectories of these mobile devices as they move and operate in their environment may be leveraged into ML models to optimize operation of the mobile device(s), and/or to address dangerous circumstances, via object/event detection approaches. Thus, an embodiment may provide smart services to improve the autonomy, and operation, of these mobile edge devices, and thereby provide value to customers. The following subsections discuss some example aspects of one or more embodiments including, but not limited to, lazy feature selection, sensor data collection, model training, and inferencing at the edge.

### C.1 Lazy Feature Selection

As used herein, a ‘feature’ as used herein may comprise data and information gathered and/or generated by a sensor concerning, for example, one or both of (1) the operation of a mobile edge device at which the sensor is deployed, and (2) a condition in an environment where the mobile edge device may be operating. A given feature may have fixed, or variable, values. Thus, example features may include, but are not limited to, GPS (global positioning system) information such as latitude, longitude, and altitude, accelerometer information such as the times when the acceleration started/ended and the velocities at the beginning/end of the acceleration, edge device information such as the position/orientation of the forks of a forklift, and LiDAR (light detecting and ranging) information such as the distance from a reference point to a point of interest, and information such as where in/on an AMR a sensor is located. As noted elsewhere herein, a ‘data point’ may comprise a set of feature values, that is, respective values of one or more features.

The phrase ‘lazy feature selection’ as used herein includes the idea that, in an embodiment, feature values may not necessarily be selected or obtained from all of the sensors that may be available in a given environment, but only from a subset of those sensors, where the members of a subset may be identified as disclosed elsewhere herein. Lazy feature selection may be performed using feature selection methods capable of assessing the attribute values of the data points to be classified, and using that information to select the subset of features that better discriminate the classes for a particular data point.

Lazy feature selection may be useful in scenarios where the importance of features may vary highly between the data points. For example, to perform a prediction, such as a classification of an event, in one corner of a warehouse, features A and B may be the most suitable. However, on the other corner of the warehouse, features C and D may be the most suitable. Moreover, the next time a prediction is needed in the same corner, a different set of features may be most suitable. Thus, the particular features used for predictions by an ML model in a given scenario may change, possibly on an ongoing basis.

Note that, this kind of adaptation, in terms of the features/feature values that may be employed in any particular circumstances or scenario, is difficult in traditional model construction and in traditional feature selection where the subset of features selected is fixed. One example of such traditional approaches is the so-called ‘lazy entropy’ method which employs a feature importance measure to evaluate the importance of a feature value to discriminate the correct class. In the lazy entropy method, given a data point to be classified, the measure is used to evaluate the subset of features that maximize the entropy between the values and the classes in the training data. These features are then selected to perform the final classification. Further information concerning a lazy entropy method can be found in Pereira, R. B., Plastino, A., Zadrozny, B., de C Merschmann, L. H. and Freitas, A. A., 2011. Lazy attribute selection: Choosing attributes at classification time. Intelligent Data Analysis, 15(5), pp.715-732, which is incorporated herein in its entirety by this reference.

C.2 Adapting Classification Algorithms to Perform Predictions with Various Input Sizes

Since the input size may according to the data point to be classified, an embodiment may use ML models that can change dynamically. Examples of such models that may be used in one or more embodiments include decision trees with lazy construction, k-nearest neighbors, bayesian networks and naïve bayes algorithm.

For example, given the naïve bayes classifier that assigns a class label y=Cₖ for some k as follows:

$$y = arg {max}_{k ∈ \{ 1 , … , K \}} p ( {C}_{k} ) {\prod }_{i = 1}^{n} p ( {x}_{i} \vert {C}_{k} )$$

In a data point, xᵢ represents a feature value. When performing lazy feature selection, an embodiment may adapt this procedure dynamically since some values of i in the product of the previous formula may be skipped. That is, an embodiment may skip the product of features that are discarded by the feature selection algorithm.

### C.3 Sensor Data Collection

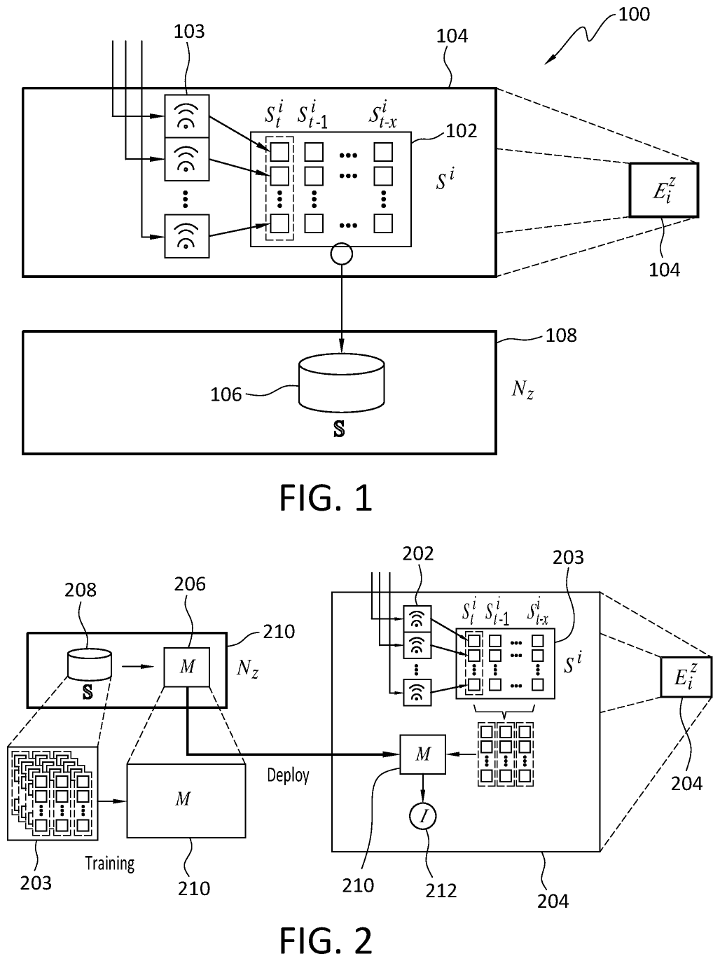

An embodiment may assume data collected at the near edge from sensors deployed at each mobile edge device individually. Each mobile edge device may comprise several sensors and collect, over time, multiple readings into a combined sensor stream. This is shown in the configuration 100 of FIG. 1, where the configuration 100 comprises a collection 102 of sensor readings Sⁱ from sensors 103 of a mobile edge device Eᵢ^{z} 104. The sensor readings Sⁱ obtained by the mobile edge device Eᵢ^{z} 104 may be added to a database 106 of sensor readings [symbol] located at a near edge node N_{z} 108.

In FIG. 1 includes a representation of distinct sensors 103 at mobile edge device Eᵢ 104 whose readings are aggregated into a sensor stream Sᵢ of collections sₜⁱ, sₜ₋₁ⁱ, sₜ₋ₓⁱ . . . . As depicted in FIG. 1, an embodiment may assume that collection of sensor readings can be correlated among themselves. That is, a sensor reading may not change from one collection to another so that the two data collections, at least as to that sensor reading, may be correlated with each other since the sensor reading has not changed.

In an embodiment, a collection of sensor readings may be triggered periodically, or by a change in values, for example, a collection may be performed every time an acceleration or deceleration is observed, or a combination of both of these. The collection sₜ is the most recent collection at time t. In this context, an embodiment may assume at least x previous collections are stored within an edge node, such as the mobile edge device Eᵢ 104.

Some collections may not contain valid readings for certain sensors, such as when a sensor malfunctions, or is functioning properly but is unable to collect a reading due to conditions in the environment and/or conditions involving the operation of an AMR, for example. Some sensor reading collections may comprise valid positioning data that can be mapped into the coordinates of an environment. Examples of such positioning data include, but are not limited to, GPS measurements in a warehouse, Wi-Fi triangulation, and RFID positioning. Example additional information may include inertial measurements of acceleration and deceleration such as may be obtained from an inertial measurement unit (IMU), as well as bearing and other kinds of rich movement tracking such as, in the illustrative example of a forklift, mast position, and load weight.

### C.4 Model Training and Inference at the Edge

With attention now to FIG. 2, there is disclosed a procedure for training of a machine learning model at a near edge node and the deployment of the resulting model at the edge. In an embodiment, a collection of sensors 202 may generate sensor readings 203 that may be used at a mobile edge device 204 for decision making, and the sensor readings 203 may also be eventually collected at a near edge site 206, such as in a database 208 for example. An approach for relying on machine learning may comprise the training of a model M 210 at the near edge site 206, as depicted in FIG. 2. The model M 210 obtained may then be deployed at each edge-node, such as the mobile edge device 204. Leveraging the sensor readings most recently collected, the inference I 212 generated by the model M 210 may be used, such as by the mobile edge device 204, for decision making in very quick fashion, that is, with very little delay. For example, the inference I 212 may be used to cause the mobile edge device 204 to take evasive action if an obstacle is present in the path of the mobile edge device 204. Another example application for such a model would be to perform event detection. For example, the model M 210 may be trained to provide as inference I 212 an indication of events of interest that may affect the operation of an AMR in an environment. It is noted that several models may be trained and deployed in a similar fashion concurrently, that is, a single mobile edge device may include multiple different models serving different respective needs.

### C.5 Multiple Locations Environment

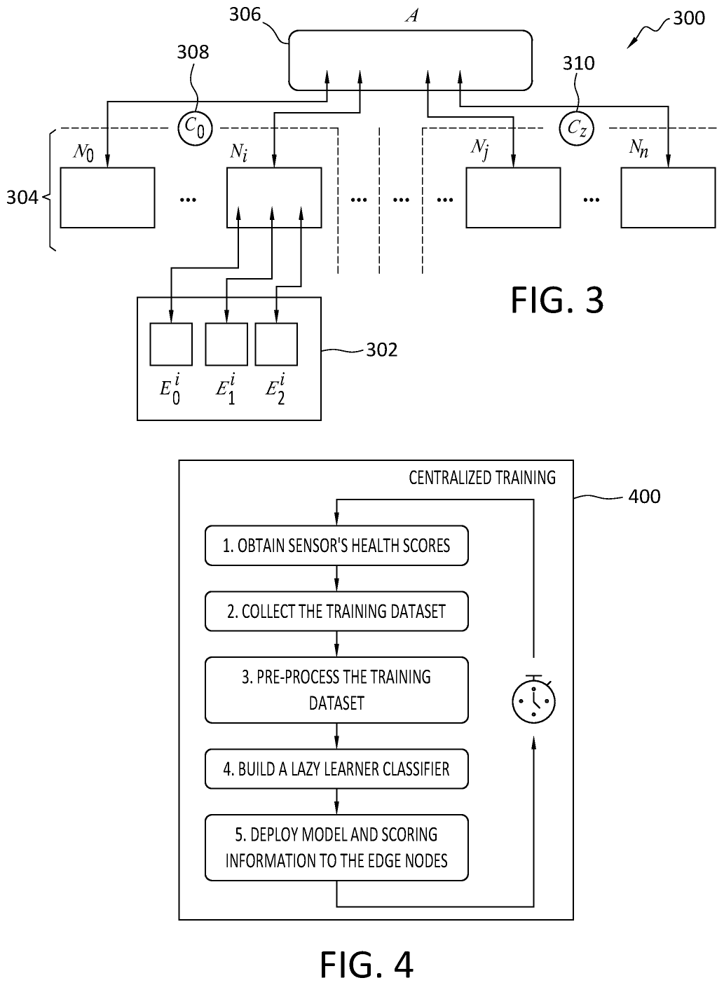

One embodiment may assume an environment as depicted in FIG. 3, which discloses a multiple-locations environment 300, with edge-nodes 302 associated to near edge nodes 304 and near edge nodes, each at a particular location in one embodiment, associated to a central node A 306. The example of FIG. 3 indicates how the central node A 306 communicates with several near edge nodes N₀ . . . Nₙ 304. The central node A 306 may represent a large-scale computational environment with appropriate permissions and connections to the near edge nodes 304. In one example embodiment, the central node A 306 may comprise local infrastructure at a core company with multiple warehouses in a logistics space. As further indicated in FIG. 3, each near edge node 304 may be associated to several edge-nodes 302. The example of FIG. 3 highlights the node Ni and the associated edge nodes 302 E₀ⁱ, E₁ⁱ and E₂ⁱ.

In some applications, a near edge node, such as the node Ni, may be associated with many edge nodes 302, each of which may comprise multiple sensors, although FIG. 3 discloses only a few edge nodes for ease of explanation. An embodiment may assume that the edge nodes 302 comprise sufficient computational resources for the required data storage and processing as typical in providing ML services to the edge.

Note also that FIG. 3 represents the separation between two warehouses C₀ 308 and C_{z} 310. However, embodiments may be implemented in connection with a single warehouse or other operating environment, and/or in connection with multiple warehouses or other operating environments. For some embodiments of the invention, as described in detail below, it may be assumed that the near edge nodes 304 N₀ . . . Nₙ communicate directly with the central node A 306. This may not necessarily be the case however and, in some embodiments, there may be intermediate steps in the communications between the central node A 306 and the near edge nodes 304 N₀ . . . Nₙ nodes depending on characteristics of the edge environments at each warehouse, or other operating environment. For the formulation of one embodiment, the details of that communication may be abstracted, and may only refer to the concept of different warehouses, or other operating environments, for a given customer. For other embodiments, the relevant concepts may be the central node, the near edge nodes, and the edge nodes.

### D. Detailed Discussion of an Embodiment

One embodiment of the invention addresses a feature selection problem for real-time inference using multiple unreliable sensors at the edge. An embodiment may address the selection of the correct features, from among those available at the time of selection, to increase the performance of the predictive model for a given data point. That is, given a specific condition of the environment, as may be reflected by feature values in a data point, an embodiment may select the best reliable features, and adapt an ML model to use these features accordingly to improve the predictive accuracy of the ML model, which may be referred to herein simply as a ‘model.’ In an embodiment, the ML model may be adapted in real time based on the input or changes provided to the ML model. In this way, a model may quickly respond to changing conditions of an AMR and/or an environment in which the AMR is operating. A method according to one example embodiment may comprise two parts, namely, [1] a centralized training procedure, responsible for storing the data, pre-processing it and to build a machine learning model, and [2] an edge inference procedure that operates to select the best subset of features, adapt the ML model, make predictions, and update the near edge and central nodes with updated scores and/or an updated ML model.

### D.1 Example Centralized Training Procedure

As noted earlier herein, the first stage of one embodiment comprises the preparation of training in a centralized fashion. In this stage, running in a near edge node or site N (see 304 in FIG. 3), or even in a central node A (see 306 in FIG. 3), an embodiment may prepare the model (see 210 in FIG. 2) that will run inside the edge nodes. FIG. 4 shows a flowchart 400 of the procedures performed in one embodiment of this initial stage. In brief, and with reference to the example embodiment of FIG. 3, a centralized training process may operate as follows:
[1] periodically obtain feature health scores at the near edge nodes, a feature health score indicates how reliable a given feature may be considered to be—for example, if an AMR is moving quickly, the GPS information (feature) gathered by a GPS system may not be as accurate as if the AMR were stationary or, as another example, if a sensor has a low battery reading, the sensor may not be operating normally and the sensor readings (feature) may accordingly be inaccurate;
[2] obtain a dataset including samples of the dataset collected for these features;
[3] pre-process the dataset to allow the calculation of respective feature importance values for each of the various features;
[4] build a strong lazy learner by using the collected dataset. By lazy learner, we refer to any classification algorithm that can adapt to a variable number of features at inference time, where such algorithms include, but are not limited to, naïve bayes, bayesian networks, decision trees, and k-NN;
[5] deploy the model and scoring information to the edge nodes.

In an embodiment, this training process shown at 400 may be repeated after a pre-defined amount of time, or when some event triggers a new training process. Thus, for example, an iteration of the training process may be triggered, every 1 minute, every 24 hours, every 1 week, and/or when the data distribution of the environment shifts. In the next subsections, there are described in more detail some aspects of the example operations disclosed in FIG. 4.

D.1.1 Collecting Feature Health Scores from Multiple Sensors

As noted in the discussion of FIG. 4, the first part of a training procedure, as indicated in the flowchart 400, may be collecting a set of feature health scores (H) from the sensors that are deployed in the target environment. In simple terms, a feature health score is a value given by the sensor, when delivering a sensor reading, that indicates how reliable the sensor reading is. In an embodiment, sensor information may be collected from fixed sensors spread across the target environment, such as a warehouse for example, and/or from moving sensors in the edge devices in E. Thus, an embodiment may define that a set of sensors S=SE∪ST comprises (1) SE, the set of sensors operating at the edge node(s), and (2) ST, the set of sensors in the target environment. Note that the features from the environment sensors may be used by inference in all edge nodes, since all of those edge nodes may be present in the environment and, as such, an embodiment may centralize the collection of the feature health scores for the environment sensors. On the other hand, the feature health score (h) from each edge node (HE) may not need centralization and may be used only inside the respective edge nodes. In an embodiment, only the feature health scores h from the target environment (HT) are sent to the near edge node or the central node, depending on the implementation of the method.

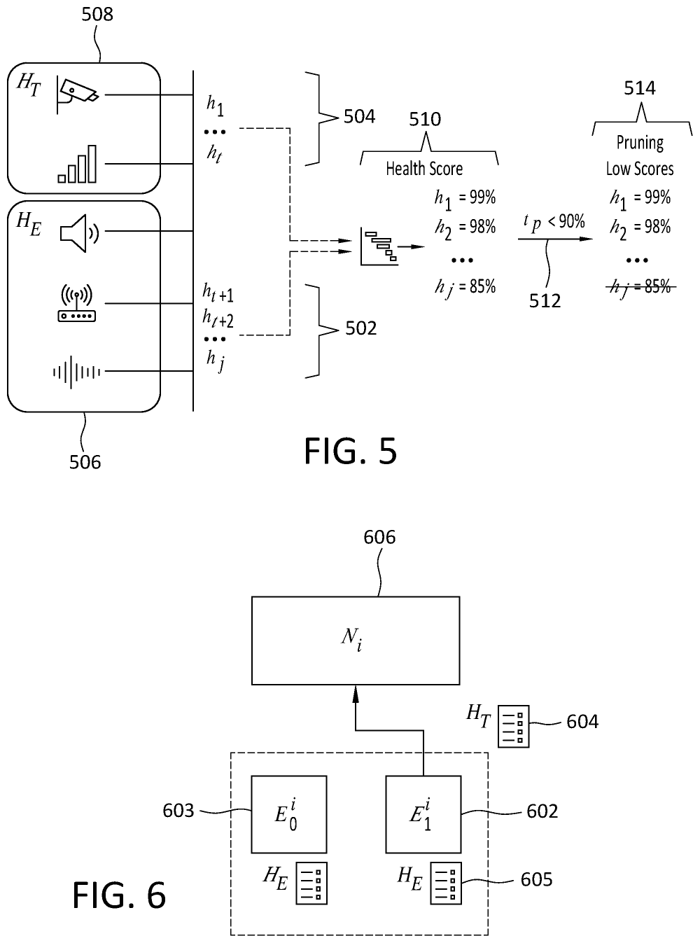

FIG. 5 provides an overview of an example process for health score collection and pre-processing. Particularly, FIG. 5 discloses collection of feature health scores 502 and 504 from edge nodes 506 H_{E} and target environment sensors 508 H_{T}, respectively. In an embodiment, the collection of both sets H_{E} and H_{T} of feature health scores 510 may only be performed by selected edge nodes, the other edge nodes may collect only H_{E} scores. To avoid using unreliable sensors that may generate information that can compromise the operation of a model, and compromise the results produced by the model, an embodiment may define a threshold of minimum acceptance of health score values defined as tₚ 512. So, when the health score value h is low, an embodiment may penalize the weight of the feature, to which that health score corresponds, in the final selection. To illustrate, if h<tₚ, an embodiment may set the weight value for that health score value h to 0. Any other value may be applied, but one embodiment may select ‘0’ to drastically remove the unreliable features from the dataset, as shown in the pruning operation 514.

With continued attention to FIG. 5, and directing attention to FIG. 6 as well, not all edge nodes may be used to collect information about the health scores of the environment sensors (ST), as shown in FIG. 6 where a selected edge node Eᵢ sends feature health scores from environment sensors to a near edge node Nᵢ. Thus, when a collection procedure begins, an embodiment may choose the edge node(s) 602 near the environment sensors, but not another edge node 603 which may be distant from the environment sensors, as the elected collectors to summarize and centralize the environment sensor feature health score information 604, as well as health score information 605 concerning the sensors of that edge node 602. This reduces the processing needed to be performed by the edge nodes, since only few of them may be selected as collectors. After collecting and processing the feature health score information, an embodiment may send the corresponding feature score h values to the near edge node 606, this information will then be used by the edge nodes in the inference and feature selection procedure. Note that as the positions of edge sensors change in the target environment, the edge sensors chosen to perform the gathering of health value score information from the environmental sensor(s) may change.

### D.1.2 Collecting Training Data, Preprocessing, and Training the Model

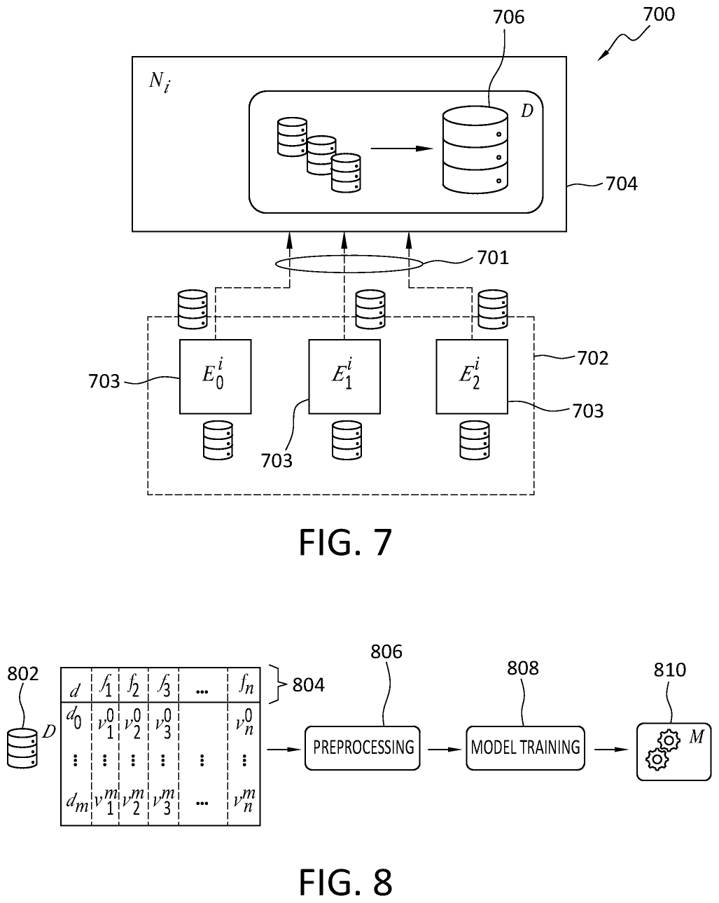

The second stage of a training procedure, according to one embodiment, includes collecting training data to build the machine learning model, and collecting information to perform the lazy feature selection procedure. The collection of data may be performed by the edge nodes in an environment. Each edge node may store an amount of data that may then be transferred to a near edge node, or the central node, depending on the implementation details. FIG. 7 shows an example process 700 for collecting training data 701 from a group 702 of edge nodes 703 and the transmission of that training data to a centralized server 704, where the training data may be stored in a database 706. That is, FIG. 7 discloses the aggregation of a training dataset in the near edge node 704. Afterwards, the aggregated data may be transferred from the near edge node(s) 704 to a central node A, an example of which is disclosed in FIG. 3.

After training data collection, as exemplified in FIG. 7, an embodiment may then, as disclosed in the example of FIG. 8, build a dataset D 802 comprising m data points. Particularly, FIG. 8 discloses example operations involved in building a training dataset, preprocessing the data, and training a machine learning model. In an embodiment, the dataset 802 may contain n features f₁, f₂ . . . fₙ 804. In the example of FIG. 8, the value of the feature n in the data point m is indicated by vₙ^{m}.

The dataset D 802 may then be preprocessed 806. A preprocessing step may include methods for normalizing data, discretizing numerical values into specific intervals, discarding outliers and other additional processes. Lastly, an embodiment may build and train 808 a strong lazy learner classifier M 810 by using the collected dataset. As noted herein, a ‘lazy learner’ may comprise any classification algorithm that can adapt to a variable number of features at inference time, such as naïve bayes, bayesian networks, decision trees, and k-NN. The model M 810 may also include information about the preprocessing operations 806 to help in a feature selection operation, as discussed below.

### D.1.3 Deploy the Model to All Edge Nodes for Inference

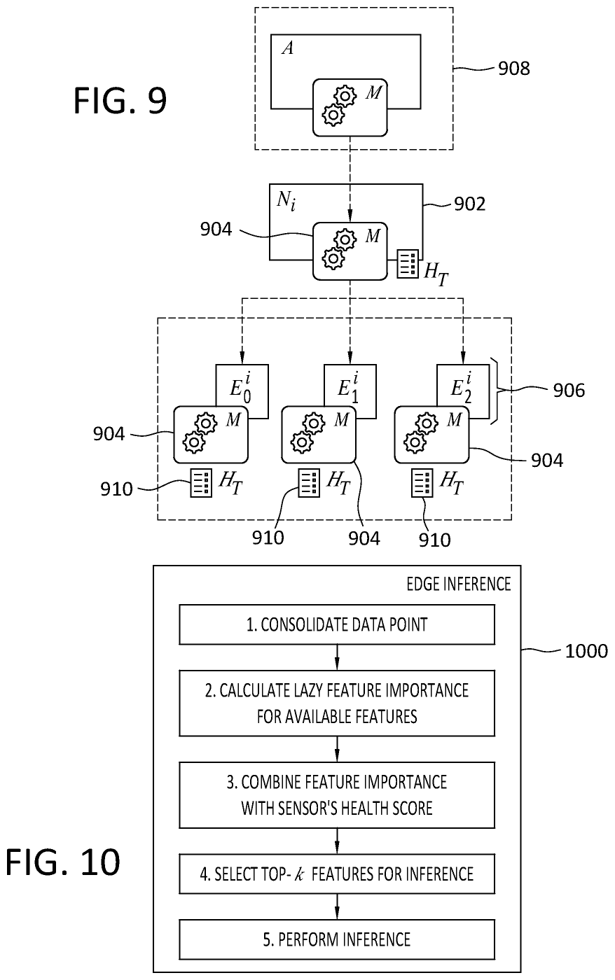

Finally, the next step of a training procedure according to one embodiment is deploying the trained model to production. FIG. 9 illustrates an example deployment process for deployment of a model M to a production environment, such as a logistics environment in which one or more AMRs are operating.

At the deployment stage, a near edge node Nᵢ 902 may send a respective instance of the model 904 to all edge nodes 906 related to its environment. Alternatively, when the training process is executed in a central node A 908, all near edge nodes, including the near edge node Nᵢ 902, associated with central node A 908, may receive an instance of the model 904 and then propagates the model 904 instances to the far edge nodes 906 in E. This example deployment stage may also comprise distributing to all edge nodes the feature health scores Hₜ collected from the environment sensors 910 H_{T} by the selected edge nodes 906.

### D.2 Edge Inference

In an embodiment, an edge inference procedure may comprise a procedure in which the actual model runs to make predictions. So, every edge node in E may run this procedure. An example of such a procedure 1000 is detailed in FIG. 10. One example of an edge inference procedure 100 may operate as follows:
[1] at inference time, consolidate a data point inside the Autonomous Mobile Robot (AMR) (or any edge device) for inference;
[2] given the data point, calculate the (lazy) feature importance for each one of the features having a feature value that is included in the data point;
[3] the feature importance per data point may then be combined with the feature health score to obtain a final feature score for the feature;
[4] for the data point, select the top-k features according to the final feature score, possibly considering both the capacity to perform a good prediction and the health of the sensor from which the data comes—note that since an embodiment may involve a large number of sensors and features, the selected subset of features may be used for a number of rounds (predictions) in order to avoid increasing the computation time—alternatively, an embodiment may set a threshold of feature rank score so that, instead of selecting top-k features, an embodiment may select all features with scores higher than a threshold; and
[5] use the subset of features to perform the prediction in the lazy learner classifier, trained in part 4 of the training process 400.

### D.3 Combining Lazy Feature Importance and Health Score to Improve Predictions

Whenever a prediction is necessary, that is, when a mobile edge device needs a model to be able to predict, or classify, an event such as may occur in an operating environment, an embodiment may start collecting, and aggregating, the input to the model, that is, to a data point dᵢ. This data point may be formed to comprise sensor data collected during the execution of the edge node, that is, dᵢ may comprise a set of feature values v₁ⁱ . . . v₁ⁿ, where each feature value comes from a different respective feature in f₁ . . . fₙ. This operation may predict a class y from dᵢ using the machine learning model M, thus: y←M(dᵢ).

An environment where the edge nodes are deployed may be very unstable, and the feature values can be unreliable and may change often. Thus, an embodiment may employ a lazy feature selection in dᵢ so that the final prediction uses only the features with good feature health values, particularly, only the feature subset most suitable for performing a good prediction for the given data point. Thus, the lazy feature selection process may enable an embodiment to quickly adjust to changing conditions since that process may employ only a subset of features that meet particular criteria for reliability. Without the lazy feature selection process, all features would have to be considered for every change in the environment, and this may not be a practical or feasible approach.

In an embodiment, and with reference to the example of FIG. 10, a lazy feature selection process may be performed, for example, by ranking the features according to their reliability from the feature health score H=H_{E}∪H_{T} and the lazy feature importance given by lazyFI. The lazyFI vector may be calculated using any lazy feature selection measure available in the literature, such as lazy entropy. Some of these feature importance measure can pre-compute some values in a table to makes the computation faster, in this case, an embodiment may pre-compute these tables in a central node, or near edge node, and then deploy the table(s) together with the model M to the edge nodes. The following equation 1102 defines an example feature rank r that may be used to select the subset of features used in the classification:

$$r ← α * lazyFI + β * H .$$

In the foregoing equation, lazyFI is a vector 1104 containing the feature importance of each feature value in the data point, H is a vector 1106 containing the feature health scores, α and β are adjustment parameters 1108 to weight the final ranking, that is, to generate a feature rank 1110. By default, the adjustment parameters α and β may be set as 1.

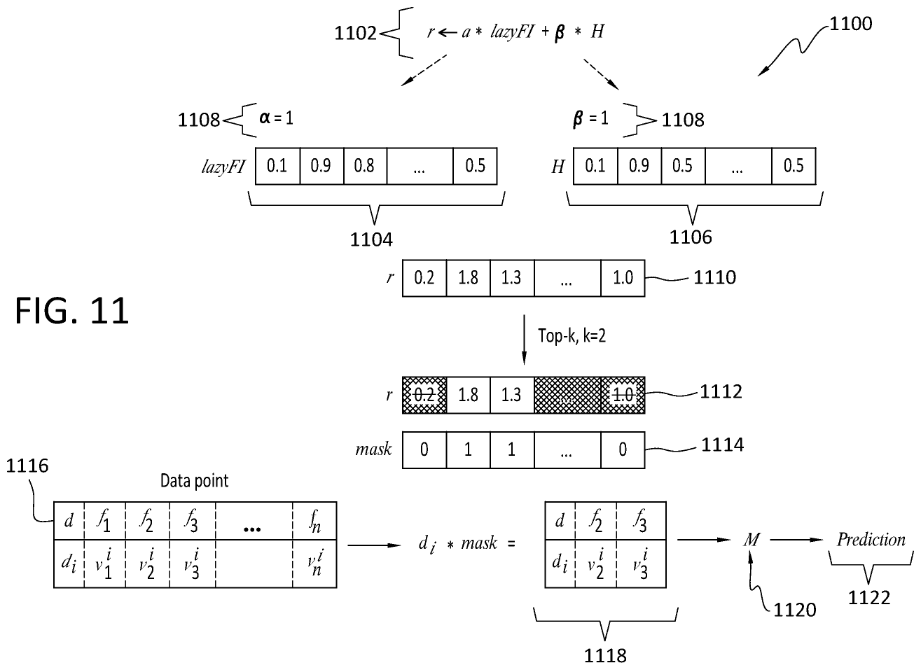

After calculating r, an embodiment may select the top k features 1112 and use the selected features 1112 as the input to the prediction method. The value of k may be a pre-defined value that may be set by an expert and may ideally be a value lower than the total number of features. Alternatively, an embodiment may set a threshold of feature rank score. So, instead of selecting top-k features, an embodiment may select all features with scores higher than a threshold. The process of selecting the features may generate a mask vector mask 1114 that may be multiplied by the input data point dᵢ 1116 to generate the correct input 1118 to the model M 1120, which may then generate predictions 1122. Thus, FIG. 11 discloses an example method of prediction using feature selection and the combined score, that is, a prediction process that may be performed after feature selection in an edge node.

### E. Example Methods

It is noted with respect to the disclosed methods, including the example methods disclosed in the Figures, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### F. Further Example Embodiments

Following are some further example embodiments of the invention. These are presented only by way of example and are not intended to limit the scope of the invention in any way.

Embodiment 1. A method, comprising: consolidating a data point concerning an autonomous mobile robot that operates in an environment; calculating a lazy feature importance for an available feature of the data point; combining the lazy feature importance with a health score of a sensor that collected data associated with the available feature, to obtain a final feature score for the available feature; selecting a subset of features of the data point; and performing, with a machine learning model, an inference, using only those features in the subset of features, and the inference concerns an aspect of the autonomous mobile robot or the environment.

Embodiment 2. The method as recited in any preceding embodiment, wherein the data point comprises a set of feature values that each pertain to a respective feature.

Embodiment 3. The method as recited in any preceding embodiment, wherein the available feature is a feature of either the autonomous mobile robot, or of the environment.

Embodiment 4. The method as recited in any preceding embodiment, wherein the inference comprises a prediction or classification of an event detected, or anticipated, in the environment by the autonomous mobile robot.

Embodiment 5. The method as recited in any preceding embodiment, wherein the model comprises a lazy learner classifier.

Embodiment 6. The method as recited in any preceding embodiment, wherein the model is operable to run on an edge device.

Embodiment 7. The method as recited in any preceding embodiment, wherein the health score indicates a level of reliability of the sensor.

Embodiment 8. The method as recited in any preceding embodiment, wherein the lazy feature importance is determined based on data collected by the sensor.

Embodiment 9. The method as recited in any preceding embodiment, wherein the sensor comprises a sensor deployed on the autonomous mobile robot, or a sensor in the environment.

Embodiment 10. The method as recited in any preceding embodiment, wherein the machine learning model is updated, with the features in the subset of features, in real time.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### G. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

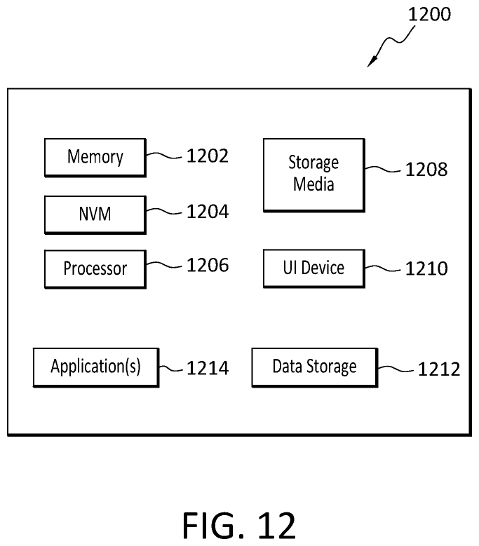

With reference briefly now to FIG. 12, any one or more of the entities disclosed, or implied, by FIGS. 1-11, and/or elsewhere herein, may take the form of, or include, or be implemented on, or hosted by, a physical computing device, one example of which is denoted at 1200. As well, where any of the aforementioned elements comprise or consist of a virtual machine (VM), that VM may constitute a virtualization of any combination of the physical components disclosed in FIG. 12.

In the example of FIG. 12, the physical computing device 1200 includes a memory 1202 which may include one, some, or all, of random access memory (RAM), non-volatile memory (NVM) 1204 such as NVRAM for example, read-only memory (ROM), and persistent memory, one or more hardware processors 1206, non-transitory storage media 1208, UI device 1210, and data storage 1212. One or more of the memory components 1202 of the physical computing device 1200 may take the form of solid state device (SSD) storage. As well, one or more applications 1214 may be provided that comprise instructions executable by one or more hardware processors 1206 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
consolidating a data point concerning an autonomous mobile robot that operates in an environment;
calculating a lazy feature importance for an available feature of the data point;
combining the lazy feature importance with a health score of a sensor that collected data associated with the available feature, to obtain a final feature score for the available feature;
selecting a subset of features of the data point; and
performing, with a machine learning model, an inference, using only those features in the subset of features, and the inference concerns an aspect of the autonomous mobile robot or the environment.

2. The method as recited in claim 1, wherein the data point comprises a set of feature values that each pertain to a respective feature.

3. The method as recited in claim 1, wherein the available feature is a feature of either the autonomous mobile robot, or of the environment.

4. The method as recited in claim 1, wherein the inference comprises a prediction or classification of an event detected, or anticipated, in the environment by the autonomous mobile robot.

5. The method as recited in claim 1, wherein the model comprises a lazy learner classifier.

6. The method as recited in claim 1, wherein the model is operable to run on an edge device.

7. The method as recited in claim 1, wherein the health score indicates a level of reliability of the sensor.

8. The method as recited in claim 1, wherein the lazy feature importance is determined based on data collected by the sensor.

9. The method as recited in claim 1, wherein the sensor comprises a sensor deployed on the autonomous mobile robot, or a sensor in the environment.

10. The method as recited in claim 1, wherein the machine learning model is updated, with the features in the subset of features, in real time.

11. A non-transitory storage medium having stored therein instructions that are executable by one or more hardware processors to perform operations comprising:
consolidating a data point concerning an autonomous mobile robot that operates in an environment;
calculating a lazy feature importance for an available feature of the data point;
combining the lazy feature importance with a health score of a sensor that collected data associated with the available feature, to obtain a final feature score for the available feature;
selecting a subset of features of the data point; and
performing, with a machine learning model, an inference, using only those features in the subset of features, and the inference concerns an aspect of the autonomous mobile robot or the environment.

12. The non-transitory storage medium as recited in claim 11, wherein the data point comprises a set of feature values that each pertain to a respective feature.

13. The non-transitory storage medium as recited in claim 11, wherein the available feature is a feature of either the autonomous mobile robot, or of the environment.

14. The non-transitory storage medium as recited in claim 11, wherein the inference comprises a prediction or classification of an event detected, or anticipated, in the environment by the autonomous mobile robot.

15. The non-transitory storage medium as recited in claim 11, wherein the model comprises a lazy learner classifier.

16. The non-transitory storage medium as recited in claim 11, wherein the model is operable to run on an edge device.

17. The non-transitory storage medium as recited in claim 11, wherein the health score indicates a level of reliability of the sensor.

18. The non-transitory storage medium as recited in claim 11, wherein the lazy feature importance is determined based on data collected by the sensor.

19. The non-transitory storage medium as recited in claim 11, wherein the sensor comprises a sensor deployed on the autonomous mobile robot, or a sensor in the environment.

20. The non-transitory storage medium as recited in claim 11, wherein the machine learning model is updated, with the features in the subset of features, in real time.
